(19) United States
(12) Patent Application Publication
(10) Pub. No.: US 2003/0184046 A1
(43) Pub. Date: Oct. 2, 2003

(54) Removable hitch system

(76) Inventors: Gaetan Bourgault, Val-Alain (CA); Simon Bourgault, Val-Alain (CA)

Correspondence Address: Mr. Gaetan Bourgault, 687, 4ieme rang, Val-Alain, QC, G0S 3H0, CA

(21) Appl. No.: 10/107,730

(22) Filed: Mar. 28, 2002

(51) Int. Cl. B60D 1/07

(52) U.S. Cl. 280/417.1; 280/441.2

(57) ABSTRACT

The present invention is a removable hitch system adapted to couple a conventional trailer or the like to a point attachment in the bed or floor of the towing vehicle.

### BACKGROUND OF THE INVENTION

1. Field of the Invention

The present invention relates to a removable hitch system adapted to couple a conventional trailer or the like to a point attachment in the bed or floor of a towing vehicle.

2. Description of the Related Art

A search of prior art records has unveiled the following patents:

1. U.S. Pat. No. 3,889,978 issued in 1975 to Kann;

2. U.S. Pat. No. 3,815,936 issued in 1974 to Oaks.

As can be seen the patents to Kann and Oaks are probably the most relevant. The patent to Oaks shows an apparatus for removable connection to a conventional trailer to enable it to be coupled to a towing vehicle at a point vertically over the rear axle of the towing vehicle; and the patent to Kann shows a detachable gooseneck hitch which has adjustment features readily adapting it to employment in conjunction with previously existing tow system components.

The proposed system shows a removable hitch system adapted to couple a conventional trailer or the like to a point attachment fixed in the bed or floor of a towing vehicle, which the transverse bars provided with aligned spaced holes are mounted to the rods provided with holes fixed in the bed or floor of the towing vehicle, which can be removed of the towing vehicle in little time, so as to do not obstruct the other uses of the towing vehicle.

### SUMMARY OF THE INVENTION

The removable hitch system of the present invention allows to couple a conventional trailer or the like to a point attachment fixed in the bed or floor of the towing vehicle, which the transverse bars provided with aligned spaced holes are mounted to the rods provided with holes fixed in the bed or floor of the towing vehicle, which can be removed of the towing vehicle in little time so as to do not obstruct the other uses of the towing vehicle, and for maximum stability, the stabilizing bars of removable hitch system are connected to the trailer tongue and at the hitch cross-plate member of hitch system receiving the hitch ball of the trailer.

### BRIEF DESCRIPTION OF THE SEVERAL VIEWS OF THE DRAWING(S)

FIG. 1 is a perspective view of a removable hitch system mounted at a point attachment in the bed or floor of the towing vehicle coupled to a conventional trailer.

FIG. 2 is a perspective view of removable hitch system adapted for fifth wheel mounted at a point attachment in the bed or floor of the towing vehicle coupled to a conventional trailer.

FIG. 3 is a side elevational view of removable hitch system corresponding to FIG. 1.

FIG. 4a is a top elevational view of removable hitch system corresponding to FIG. 1.

FIG. 4b is a side elevational view of removable hitch system thereof.

FIG. 5a is a top elevational view of removable hitch system adapted for fifth wheel corresponding to FIG. 2.

FIG. 5b is a side elevational view of removable hitch system adapted for fifth wheel thereof.

FIG. 6 is an exploded view of removable hitch system corresponding to FIG. 1.

FIG. 7 is an exploded view of removable hitch system adapted for fifth wheel corresponding to FIG. 2.

Although only a single embodiment of the present invention has been described and illustrated, the present invention is not limited to the features of this embodiment, but includes all variations and modifications within the scope of claims attached hereto without departing from the spirit of the invention.

### DETAILED DESCRIPTION OF THE INVENTION

Referring to the drawings in more detail, it may be seen that the removable hitch system (A) of the present invention is adapted to couple a conventional trailer having a tongue and a ball-receiving hitch on the tongue to a motor vehicle, such as a towing vehicle having a bed or floor.

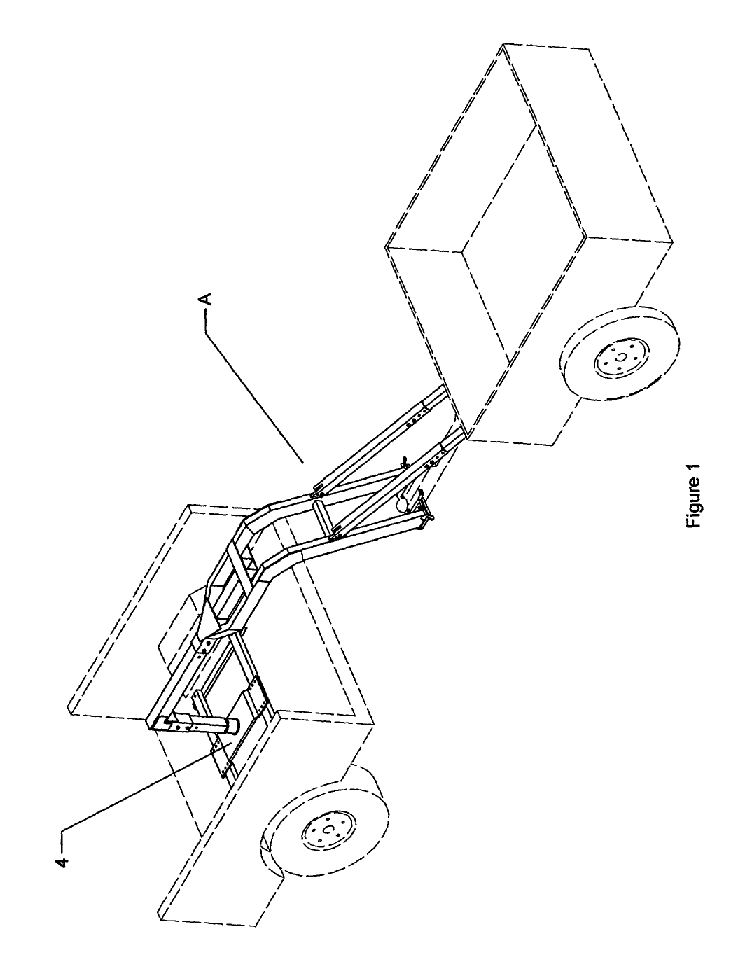

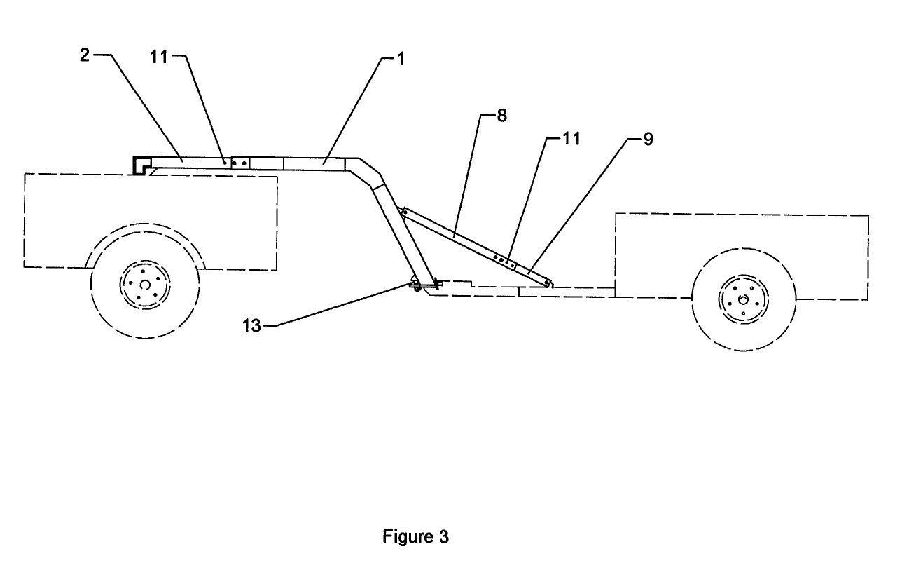

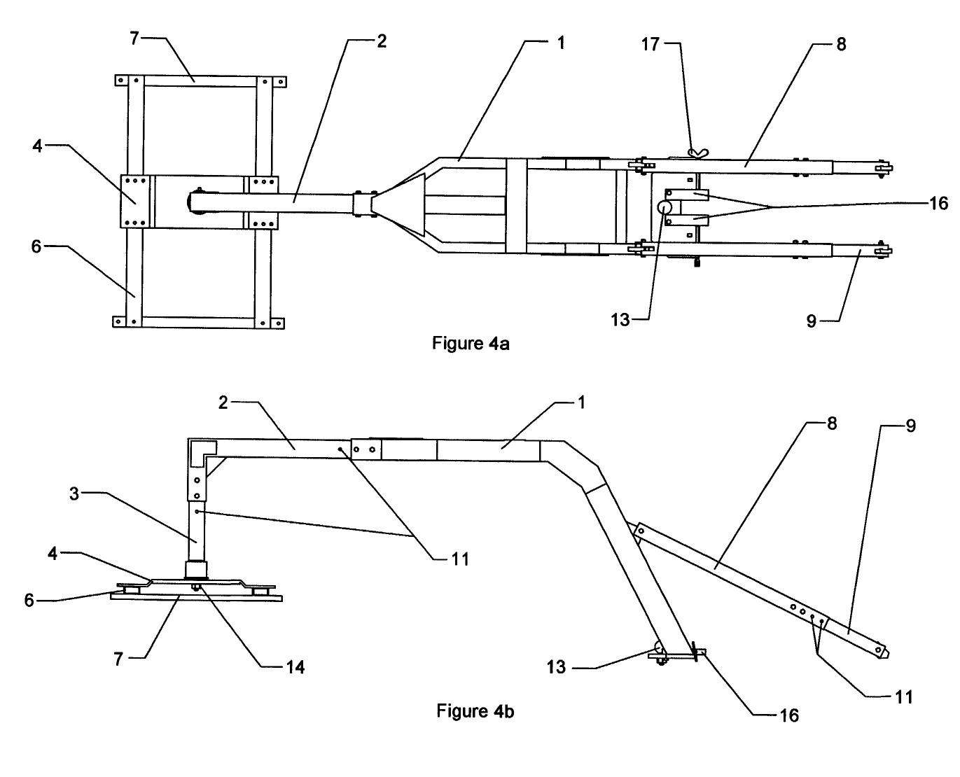

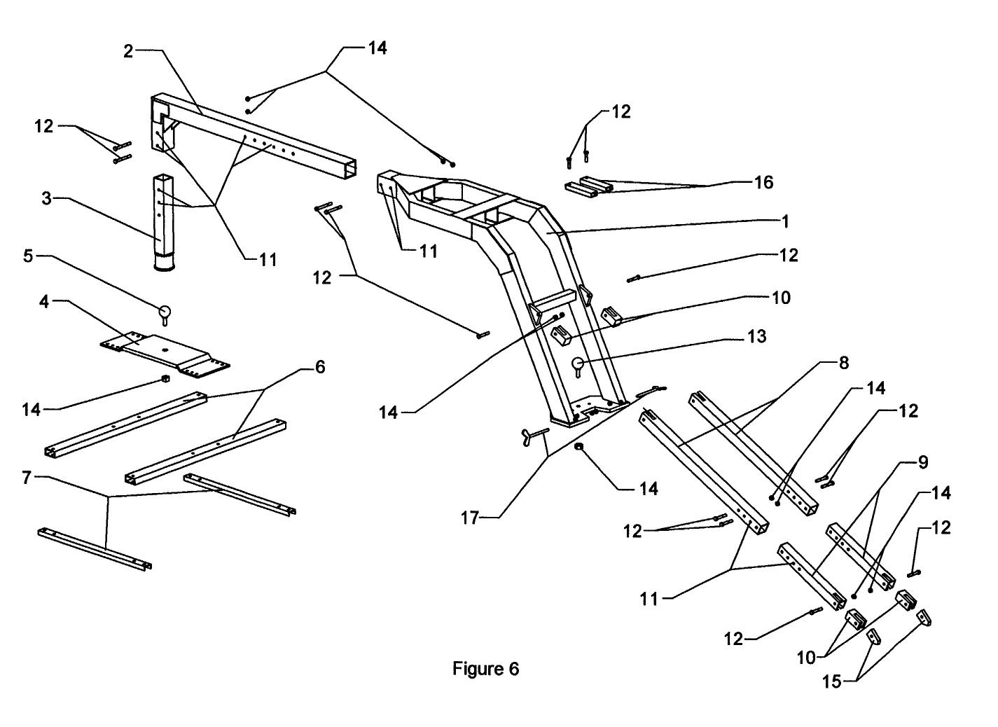

As shown in FIGS. 1, 3, 4a, 4b and 6, the hitch system (A) includes the removable transverse bars (6) provided with aligned spaced holes formed therein, allowing to connect a removable hitch plate member (4) on which is mounted a hitch ball (5) and nut (14) connected to the rods (7) provided with holes formed therein, which are fixed at a point attachment in the bed or floor of the towing vehicle.

A vertical slide member (3) is provided with aligned spaced holes (11) formed therein, allowing if desired the height adjustment of the hitch system (A), which is connected by means of attachment shown here being bolts (12) and nuts (14) to an inverted L-shaped member (2) provided with aligned spaced holes (11) formed therein, allowing the height and lenght adjustment of the hitch system (A), and which is engaged onto the hitch ball (5). The member (2) is also connected into holes (11) to the upper end of a structural member (1) by means of attachment shown here being bolts (12) and nuts (14) blocking the member (2) according to the desired lenght.

The lower end of the structural member (1) is connected in a conventional fashion to a hitch cross-plate on which is mounted a hitch ball (13) and nut (14) to the tongue of conventional trailer. The lower ends of side walls from the structural member (1) are joined to the hitch cross-plate provided with holes, which allows to connect the plates (16) provided with rings onto the hitch cross-plate by means of attachment shown here being kingpins (17) passing through the hitch cross-plate and nuts (14), which attach the safety chains of the trailer.

The elongated stabilizing bars (8) provided with aligned spaced holes (11) allow the lenght adjustment according to the connection joining the hitch system (A) to the trailer, and which are joined to the triangular members fixed each into holes onto the side walls of the structural member (1) by means of attachment shown here being bolts (12) and nuts (14).

The shorter bars (9) are provided with aligned spaced holes (11) formed therein, sliding into the stabilizing bars (8) being connected into holes (11) by means of attachment shown here being bolts (12) and nuts (14) blocking the shorter bars (9) according to the desired lenght.

The clip members (15) provided with holes are engaged into the inverted U-shaped members (10) provided with holes, which are engaged into the shorter bars (9) provided with aligned spaced holes (11), and are blocked in place by means of attachment shown here being bolts (12) and nuts (14), which slide into the stabilizing bars (8) that are connected into holes (11) by means of attachment shown here being bolts (12) and nuts (14) according to the desired lenght.

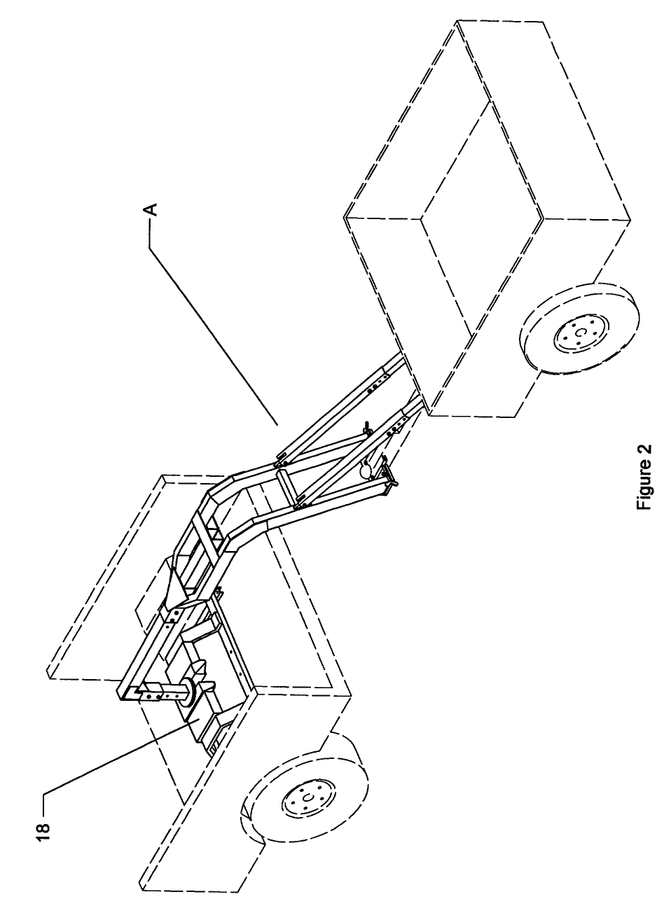

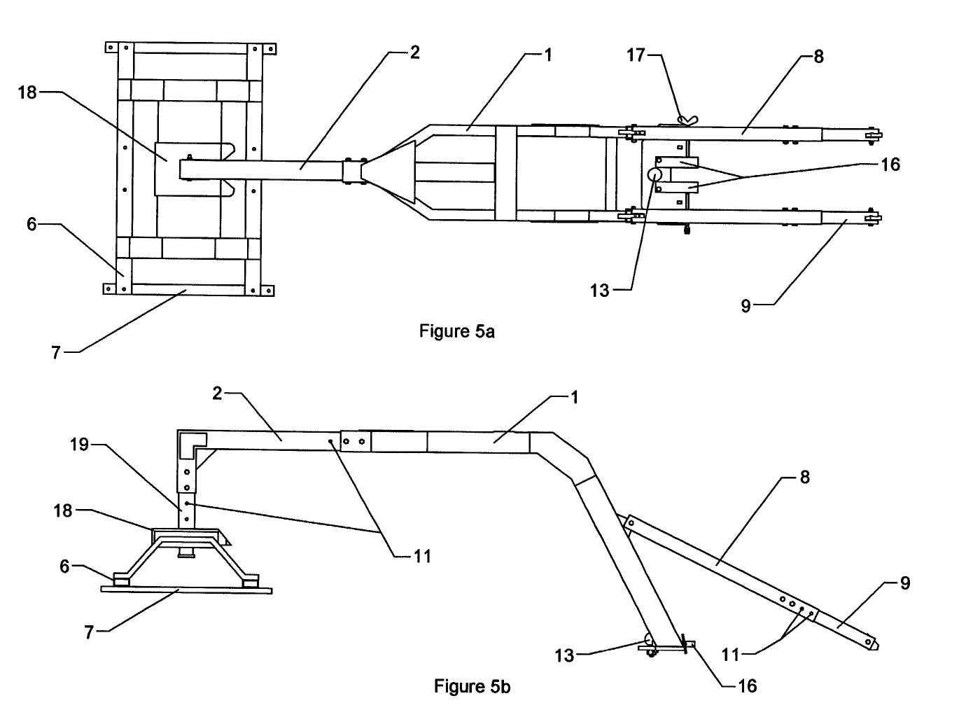

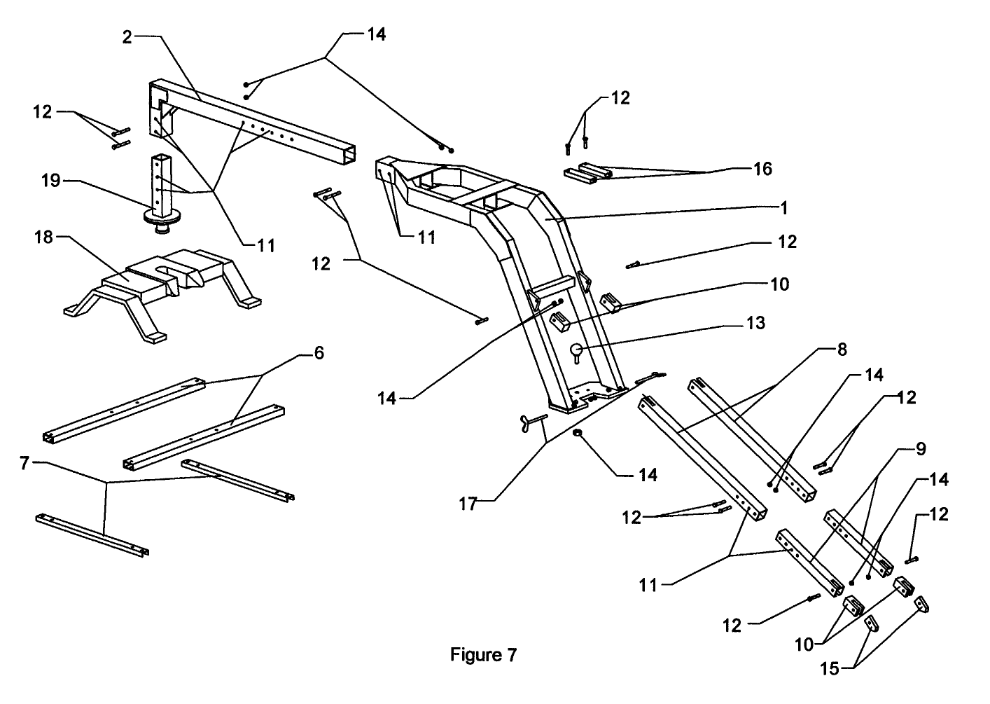

As shown in FIGS. 2, 3, 5a, 5b and 7, the hitch system (A) includes the removable transverse bars (6) provided with aligned spaced holes formed therein, allowing to connect a removable hitch plate member (18) connected to the rods (7) provided with holes formed therein, which are fixed at a point attachment in the bed or floor of the towing vehicle.

The vertical slide member (19) is provided with aligned spaced holes (11) formed therein, allowing if desired the height adjustment of the hitch system (A), which is connected by means of attachment shown here being bolts (12) and nuts (14) to an inverted L-shaped member (2) provided with aligned spaced holes (11) formed therein, allowing the height and lenght adjustment of the hitch system (A), and which is mounted onto the removable hitch plate member (18). The member (2) is also connected into holes (11) to the upper end of a structural member (1) by means of attachment shown here being bolts (12) and nuts (14) blocking the member (2) according to the desired lenght.

The lower end of the structural member (1) is connected in a conventional fashion to a hitch cross-plate on which is mounted a hitch ball (13) and nut (14) to the tongue of conventional trailer. The lower ends of side walls from the structural member (1) are joined to the hitch cross-plate provided with holes, which allows to connect the plates (16) provided with rings onto the hitch cross-plate by means of attachment shown here being kingpins (17) passing through the hitch cross-plate and nuts (14), which attach the safety chains of the trailer.

The elongated stabilizing bars (8) provided with aligned spaced holes (11) allow the lenght adjustment according to the connection joining the hitch system (A) to the trailer, and which are joined to the triangular members fixed each into holes onto the side walls of the structural member (1) by means of attachment shown here being bolts (12) and nuts (14).

The shorter bars (9) are provided with aligned spaced holes (11) formed therein, sliding into the stabilizing bars (8) being connected into holes (11) by means of attachment shown here being bolts (12) and nuts (14) blocking the shorter bars (9) according to the desired lenght.

The clip members (15) provided with holes are engaged into the inverted U-shaped members (10) provided with holes, which are engaged into the shorter bars (9) provided with aligned spaced holes (11), and are blocked in place by means of attachment shown here being bolts (12) and nuts (14), which slide into the stabilizing bars (8) that are connected into holes (11) by means of attachment shown here being bolts (12) and nuts (14) according to the desired lenght.

Although only a single embodiment of the present invention has been described and illustrated, the present invention is not limited to the features of this embodiment, but includes all variations and modifications within the scope of claims.

The embodiments of the invention for which an exclusive property or privilege is claimed, are defined as follows:

1. Removable hitch system adapted to couple a conventional trailer having a tongue and a ball-receiving hitch on the tongue, to a point attachment in the bed or floor of a towing vehicle, said removable hitch system comprising the removable transverse bars provided with aligned spaced holes allowing to connect a removable hitch plate member receiving a hitch ball and nut mounted to the rods provided with holes fixed to said point attachment in the bed or floor of said towing vehicle,
a vertical slide member provided with aligned spaced holes allows the height adjustment of said hitch system being connected by means of attachment being bolts and nuts to an inverted L-shaped member provided with said aligned spaced holes allowing to the height and lenght adjustment of said hitch system, wherein said slide member is engaged onto the said hitch ball receiving said removable hitch plate member and nut mounted to said rods provided with holes fixed to said point attachment in the bed or floor of said towing vehicle,
the inverted L-shaped member provided with said aligned spaced holes is engaged into a structural member fixed into holes by said means of attachment being bolts and nuts, wherein said structural member is connected to the hitch cross-plate receiving the hitch ball onto the tongue of the trailer, and which the lower ends of side walls from said structural member are joined to said hitch cross-plate provided with holes allowing to connect the plates provided with rings onto the said hitch cross-plate by means of attachment being kingpins passing through said hitch cross-plate, and nuts connecting the safety chains of the trailer,
the elongated stabilizing bars provided with said aligned spaced holes allow to the lenght adjustment according the connection joining said hitch system to the trailer, wherein said stabilizing bars are joined to the triangular members fixed each onto the side walls of said structural member by said means of attachment being bolts and nuts,
the shorter bars provided with said aligned spaced holes slide into the said stabilizing bars, wherein said shorter bars are fixed into holes by said means of attachment being bolts and nuts, and
the clip members provided with holes are engaged into the inverted U-shaped members provided with said aligned spaced holes, wherein said inverted U-shaped members are engaged into the said shorter bars and connected by said means of attachment being bolts and nuts.

2. Removable hitch system adapted to couple a trailer as described in claim 1, which a second alternative form of the invention is designed to allow to install said removable hitch system mounted for fifth wheel to said point attachment in the bed or floor of said towing vehicle, and wherein said hitch system is connected to a conventional trailer having a tongue and a ball-receiving hitch on the tongue.

3. Removable hitch system adapted to couple a trailer as described in claim 2, said removable hitch system comprising said removable transverse bars provided with said aligned spaced holes allowing to connect a second removable hitch plate member to said rods provided with holes fixed to said point attachment in the bed or floor of said towing vehicle,
a second vertical slide member provided with aligned spaced holes allows the height adjustment of said hitch system being connected by said means of attachment being bolts and nuts to said inverted L-shaped member provided with said aligned spaced holes allowing to the height and lenght adjustment of said hitch system, wherein said slide member is engaged onto the said removable hitch plate member connected to said rods provided with holes fixed to said point attachment in the bed or floor of said towing vehicle,
said inverted L-shaped member provided with said aligned spaced holes is engaged into said structural member fixed into holes by means of said attachment being bolts and nuts, wherein said structural member is connected to said hitch cross-plate receiving said hitch ball onto the tongue of the trailer, and which the said lower ends of side walls from said structural member are joined to said hitch cross-plate provided with holes allowing to connect said plates provided with said rings onto the said hitch cross-plate by said means of attachment being said kingpins passing through said hitch cross-plate, and said nuts connecting the safety chains of the trailer,
said elongated stabilizing bars provided with said aligned spaced holes allowing to the lenght adjustment according the connection joining said hitch system to the trailer, wherein said stabilizing bars are joined to said triangular members fixed each onto said side walls of said structural member by said means of attachment being bolts and nuts,
said shorter bars provided with said aligned spaced holes slide into the said stabilizing bars, wherein said shorter bars are fixed into holes by said means of attachment being bolts and nuts, and
said clip members provided with holes are engaged into said inverted U-shaped members provided with said aligned spaced holes, wherein said U-shaped members are engaged into said shorter bars and connected by said means of attachment being bolts and nuts.
